(19) United States
(12) Patent Application Publication
(10) Pub. No.: US 2026/0019857 A1
(43) Pub. Date: Jan. 15, 2026

(54) LAYER 2 FUNCTIONALITY SPLIT FOR CELL-FREE ARCHITECTURE

(71) Applicant: APPLE INC., Cupertino, CA (US)

(72) Inventors: Danila Zaev, Munich (DE); Ahmed Gamal Helmy Mohamed, Cupertino, CA (US); Ayman F. Naguib, Cupertino, CA (US); Naveen Kumar R. Palle Venkata, San Diego, CA (US); Norman Goris, Dortmund (DE)

(21) Appl. No.: 19/249,072

(22) Filed: Jun. 25, 2025

Related U.S. Application Data
(60) Provisional application No. 63/669,388, filed on Jul. 10, 2024.

(51) Int. Cl. H04W 24/10; H04W 72/20; H04W 80/02

(52) U.S. Cl. CPC H04W 24/10; H04W 72/20; H04W 80/02

(57) ABSTRACT

Embodiments herein provide methods, systems, and apparatuses for layer 2 (L2) functionality split for a cell-free architecture. In some embodiments a central unit may receive segments of an uplink packet data unit (PDU) via multiple edge L2 nodes. The segments may be sent by a user equipment (UE). The central unit may perform assembly of the segments of the uplink PDU from the multiple edge L2 nodes. Upon successful assembly, the central unit may send the multiple edge L2 nodes an assembly success report to inform MAC schedulers at the multiple edge L2 nodes about the successful assembly.

### TECHNICAL FIELD

This application relates generally to wireless communication systems, including splitting L2 functionalities between distributed units and a central unit.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a distributed Multiple Input Multiple Output (MIMO) configuration, in accordance with some embodiments.

FIG. 2 illustrates a centralized cell-free MIMO configuration, in accordance with some embodiments.

FIG. 3 illustrates a distributed cell-free MIMO configuration, in accordance with some embodiments.

FIG. 4 illustrates a block diagram where a single edge L2 node is used in the case of a stationary UE, in accordance with some embodiments.

FIG. 5 illustrates a block diagram where multiple edge L2 nodes are used in a cell-free architecture to support a mobile UE, in accordance with some embodiments.

FIG. 6 illustrates a block diagram where multiple edge L2 nodes are used in a cell-free architecture to support a mobile UE, in accordance with some embodiments.

FIG. 7 illustrates an example diagram where L2 functionality is split between a central part and an edge part, in accordance with some embodiments.

FIG. 8 illustrates a wireless communication system where two edge L2 nodes are in communication with a UE in accordance with some embodiments.

FIG. 9 is a table that illustrates some differences and similarities between Multi-DCI mTRP architecture and cell-free architecture in accordance with some embodiments.

FIG. 10 illustrates three options for distributed cell-Free MIMO architecture in accordance with some embodiments.

FIG. 11 illustrates an example signal flow diagram for downlink operation with two DUs to a UE in a cell-free architecture in accordance with some embodiments.

FIG. 12 illustrates an example signal flow diagram for uplink operation with two DUs to a UE in a cell-free architecture in accordance with some embodiments.

FIG. 13 illustrates an example signal flow diagram for uplink operation with two DUs to a UE in a cell-free architecture with an intra-MAC/intra-RLC split in accordance with some embodiments.

FIG. 14 illustrates a method performed by a central unit network node, according to embodiments herein.

FIG. 15 illustrates a method performed by an edge L2 node serving as a distributed unit, according to embodiments herein.

FIG. 16 illustrates a method performed by a UE, according to embodiments herein.

FIG. 17 illustrates an example architecture of a wireless communication system, according to embodiments disclosed herein.

FIG. 18 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

A traditional cell-based wireless communication system may rely on distinct base stations providing coverage to fixed cells. However, this rigid cell structure may be limited in capacity, have coverage inconsistencies, and face scalability challenges. Traditional cellular networks often suffer from uneven signal distribution, leading to zones of poor connectivity. As demand for data and connectivity grows, especially in densely populated urban areas, traditional networks can quickly become overwhelmed, leading to congestion and reduced service quality. Further, the centralized nature of traditional cellular networks can lead to higher latency, especially as the distance between the user and the base station increases.

Cell-free architecture represents an approach to network design that may address these issues. Cell-free architecture uses a plurality of distributed transmission and reception points (TRPs) communicatively coupled to edge nodes. The edge notes are communicatively coupled to a central processing unit. This design may facilitate a more uniform distribution of signal processing and reduce the differences in user experience based on location within the network. Cell-free architecture may minimize latency by bringing users closer to network access points, facilitating real-time communications and applications demanding quick response times.

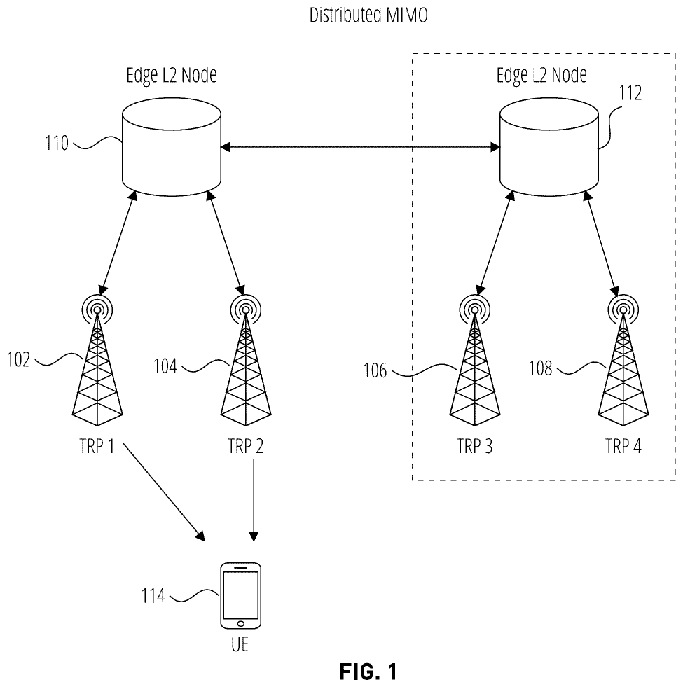

FIGS. 1-3 illustrate three different structural options that may be used to implement Multiple Input Multiple Output (MIMO). In each of these configurations, the wireless communication includes multiple TRPs that correspond to different edge layer 2 (L2) nodes. The edge L2 nodes refers to a node that provides at least some L2 functionality closer to the user than L2 functionality at a centralized node. As will be discussed in more detail below, the different configurations may be used to perform joint operation from multiple TRPs using one or more edge L2 nodes. The edge L2 nodes may also be referred to as distributed units (DUs).

Specifically, FIG. 1 illustrates a distributed Multiple Input Multiple Output (MIMO) configuration, in accordance with some embodiments. In this configuration multiple TRPs (e.g., TRP 102 and TRP 104) may be controlled by an edge layer 2 node (e.g., edge L2 node 110). The TRPs (e.g., TRP 106 and TRP 108) controlled by different edge L2 nodes (e.g., edge L2 node 112) may not be used across edge L2 nodes. For example, TRP 106 and TRP 108 may not be used for communicating with the UE 114 in joint cooperation with the TRP 102 and TRP 104.

However, the TRPs that are controlled by a same edge L2 node may perform joint operation from a physical layer perspective. By limiting the TRPs that may be used for joint operation to a single Edge L2 node, the UE 114 may suffer from poor coverage near cell borders. Cell-edge performance between L2-edge nodes may not be optimal.

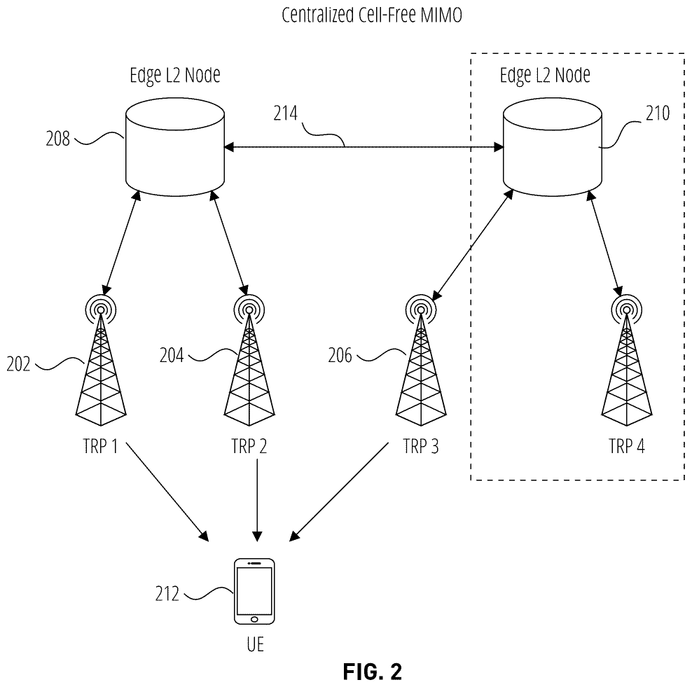

Cell-free architecture may be used for better performance between edge L2 nodes. For example, FIG. 2 illustrates a centralized cell-free MIMO configuration, in accordance with some embodiments. This configuration combines the principles of MIMO with a cell-free architecture in a centralized manner. In this configuration, a number of distributed TRPs (e.g., TRP 202, TRP 204, and TRP 206) may function as a unified array that may be used jointly or in coordination even though they are connected to different edge L2 nodes (e.g., edge L2 node 208 and edge L2 node 210).

In this centralized configuration, only one edge L2 node is controlling the communication with the UE 212. In the illustrated embodiment, the controlling edge L2 node is edge L2 node 208. Edge L2 node 208 may use TRP 206 jointly or in coordination with TRP 202 and TRP 204. With a centralized cell-free MIMO configuration, L2 functionality is implemented at one edge L2 node (e.g., edge L2 node 208). Although TRP 206 is connected with another edge L2 node, it can still be controlled through edge L2 node 208 through an inter-node interface 214 or through a centralized control interface.

The centralized cell-free MIMO configuration may avoid undesirable cell edge behavior because the UE 212 is able to communicate with TRPs from multiple edge L2 nodes. Because the L2 functions are centralized in a single edge L2 node, the inter-node interface 214 plays a pivotal role. Accordingly, an ideal inter-node interface may be required if the UE 212 has low-latency quality of service (QOS) when a centralized cell-free MIMO configuration in implemented.

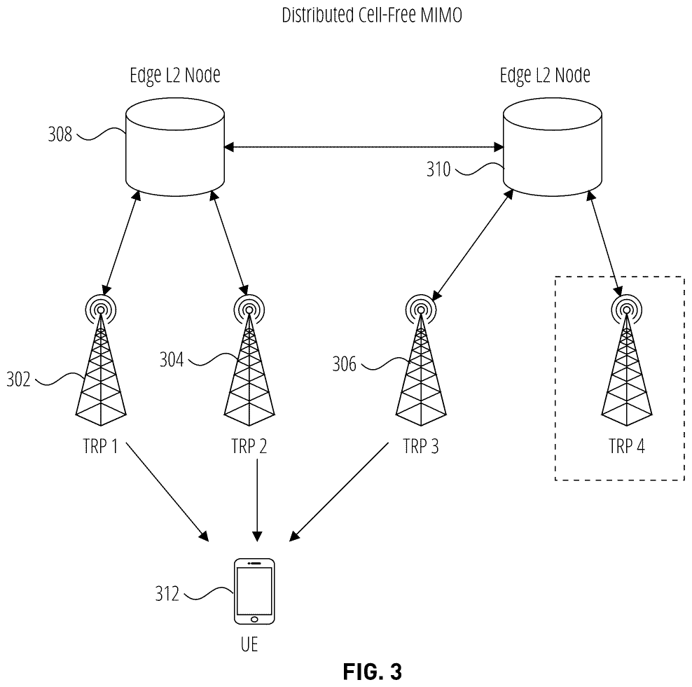

FIG. 3 illustrates a distributed cell-free MIMO configuration, in accordance with some embodiments. Similar to the centralized cell-free MIMO configuration shown in FIG. 2, in the distributed cell-free MIMO configuration the UE 312 may communicate with TRPs (e.g., TRP 302, TRP 304, and TRP 306) across multiple edge L2 nodes (e.g., edge L2 node 308 and edge L2 node 310). In addition, in the distributed cell-free MIMO configuration, more than one L2 node may be activated. For example, both edge L2 node 308 and edge L2 node 310 may be activated, and the L2 functionalities may be distributed or duplicated across the edge L2 nodes.

This distributed cell-free MIMO configuration may provide a greater flexibility. For example, the network could decide to adaptively, depending on QoS conditions, use one or more than one edge L2 node. By using TRPs across edge L2 nodes, the UE 312 may avoid undesirable cell edge behavior. Additionally, the ability to use multiple edge L2 nodes may allow the configuration to be compatible with non-ideal inter-node interfaces.

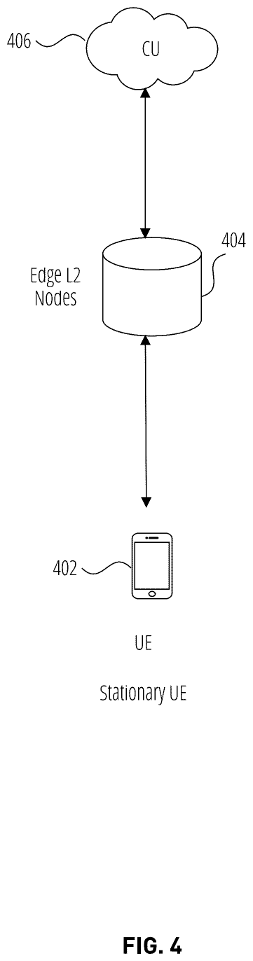

Cell-free configurations may be useful for cases where uniform low-latency service is desirable. Additionally, cell-free configurations may also be used for seamless mobility. FIGS. 4-6 illustrate how cell-free architecture can be used to provide seamless mobility. Note that in FIGS. 4-6, TRPs are not illustrated, but are assumed. The central unit (CU) is a centralized node which can implement part of the L2 functionality along with the edge L2 nodes. How the L2 functionalities may be split between the edge nodes and the CU is described in embodiments herein. The edge L2 nodes can implement low-latency functionality (e.g., Hybrid Automatic Repeat Request (HARQ)), and the edge L2 nodes may be located close to the UE.

FIG. 4 illustrates a block diagram where a single edge L2 node 404 is used in the case of a stationary UE 402, in accordance with some embodiments. Assuming that the UE 402 is stationary, a single edge L2 node 404 may be used to implement the edge L2 functionality. As shown, the UE 402 may communicate with the CU 406 through the edge L2 node 404. For example, the UE 402 may send a request for data or service to the edge L2 node 404. The Edge L2 node 404 can either handle certain tasks locally or act as a pass-through that forwards the request to the CU 406 for further processing. The CU 406, upon receiving the request and processing it may send a response back down the chain to the UE 402. The response destined for the UE 402 may be processed or repackaged by the Edge L2 node 404 before being sent back to the UE 402.

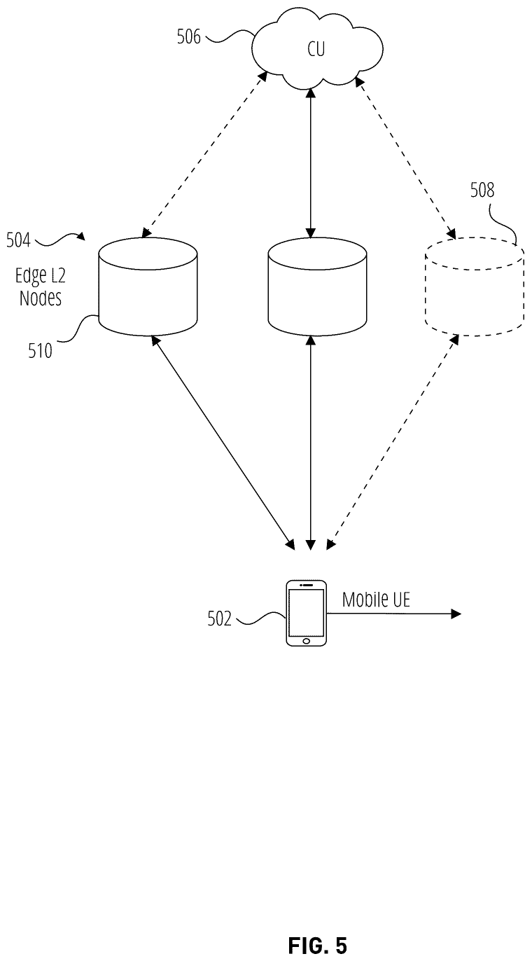

FIG. 5 illustrates a block diagram where multiple edge L2 nodes 504 are used in a cell-free architecture to support a mobile UE 502, in accordance with some embodiments. In some embodiments the UE 502 is mobile, for example if the UE 502 is in a car and may use services with low-latency requirements. To have seamless mobility which satisfies the latency requirements there may be several edge L2 nodes 504 configured and used in a cell-free architecture. For example, as the UE 502 moves, the third edge L2 node 508 may be activated to support the UE 502 as it moves out of range of a first edge L2 node 510. This arrangement may avoid jitter/delay for mobile UE moving through L2 edge node areas. The UE 502 may use any of the edge L2 nodes 504 to communicate with the CU 506.

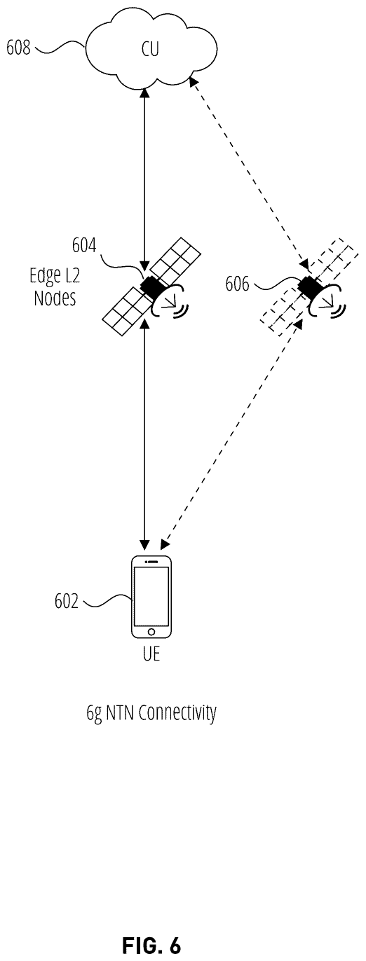

FIG. 6 illustrates a block diagram where multiple edge L2 nodes (e.g., first edge L2 node 604 and second edge L2 node 606) are used in a cell-free architecture to support a mobile UE 602, in accordance with some embodiments. Similar to the mobile UE case described with reference to FIG. 5, in some cases the edge L2 nodes may move. For example, for Non-Terrestrial Network (NTN) connectivity, the edge L2 nodes may be satellites. The second edge L2 node 606 may be activated when the first edge L2 node 604 moves out of range, allowing the UE 602 to continue communication with the CU 608. This may avoid jitter/delay for mobile UE served by Low Earth Orbit (LEO) NTN nodes in regenerative architecture.

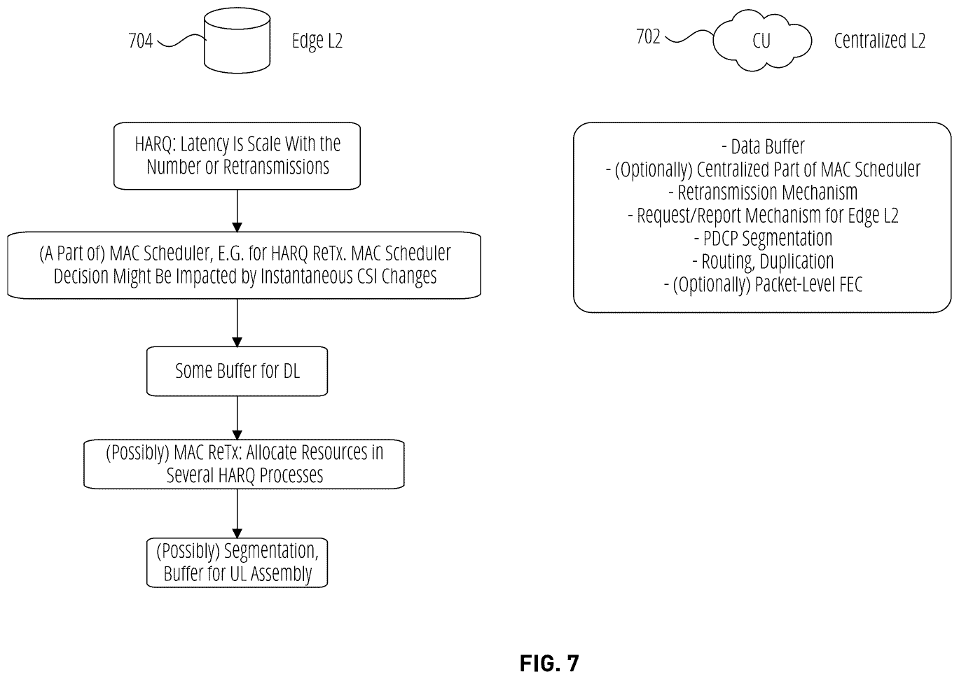

FIG. 7 illustrates an example diagram where L2 functionality is split between a central part and an edge part, in accordance with some embodiments. The central part of the L2 functionality may be implemented on the CU 702 and the edge part may be implemented on the edge L2 node 704. In some embodiments, functionality of the edge L2 node 704 can be distributed or duplicated (e.g., across other edge L2 nodes), while functionality of the CU may not be distributed or duplicated.

The list of functionalities below the edge L2 node 704 illustrates parts of L2 functionality that may benefit by being implemented closer to the user in accordance with some embodiments. The edge L2 node 704 may be referred to as a distributed unit (DU). Functionalities that are latency sensitive may be implemented at the edge L2 node 704. In some embodiments, functionalities that are implemented in the edge L2 node 704 can be distributed or duplicated by the network. Because of this, a UE may be able to maintain connection and operations for functionalities across DUs.

The functionalities on the right side of FIG. 7 may be implemented by the CU 702. These functionalities may not be as sensitive to latency. The CU 702 may be implemented by a single entity. Accordingly, the CU 702 may not have issues related to parallel decision making and processing in parallel for the functionalities the CU 702 performs.

As shown, in some embodiments, the functionalities implemented on the edge L2 node 704 may include the HARQ process. In regard to HARQ, latency is scaled with the number of retransmissions. Keeping the HARQ close to the UE may reduce the number of transmissions and therefor reduce the latency. Accordingly, in the illustrated embodiment, the HARQ is supported on the edge L2 node 704 to limit the number of retransmissions.

Given that in the illustrated embodiment HARQ is supported by the edge L2 node 704, part or all of the MAC Scheduler may be supported at the edge L2 node 704. For example, support for HARQ (retransmission) ReTx scheduling may be located on the edge L2 node 704. MAC Scheduler decisions might be impacted by instantaneous Channel State Information (CSI) changes. Transport Block size for PDSCH, PUSCH may be known at Edge L2 node 704 but not at the CU 702. Accordingly, the edge L2 node 704 may have more up to date information than the CU 702 that may provide result in a more accurate decision being made at the edge L2 node 704 level than would be made at the CU 702 level. Accordingly, in some embodiments, the final decision of the MAC Scheduler (e.g., a final decision of a MAC grant) may be up to the edge L2 node 704.

Additionally, at the edge L2 node 704 there may be buffering for downlink. When the downlink grant is generated, it may be beneficial to have data at the edge L2 node 704, to be able to provide the right amount of data for PDSCH. The buffer at the edge L2 node 704 may improve performance of the system. In some embodiments, MAC ReTx may be used at the edge L2 node 704 to allocate resources in several HARQ processes. This may provide flexibility in the HARQ process. For example, if a HARQ process runs but fails the system may keep the data and incorporate the data in another HARQ process. In some embodiments, the edge L2 node 704 may include functionality for segmentation and buffer for uplink assembly. In some embodiments, the functionalities of the edge L2 node 704 may be distributed and/or duplicated.

In the illustrated embodiment, the CU 702 includes buffer functionality. In downlink, the buffer may be used for storing data until delivery confirmation. In some embodiments, confirmation can be provided by Edge L2 node 704. In some embodiments, the CU 702 may include centralized part of MAC scheduler. In some embodiments, the CU 702 may include a retransmission mechanism. For example, in some embodiments, the CU 702 may include a request/report mechanism for edge L2 node 704. In some embodiments, the CU 702 may include functionality for Packet Data Convergence Protocol (PDCP) segmentation/reassembly. In some embodiments, the CU 702 may include functionality for Packet-level Forward Error Correction (FEC). The CU 702 may include routing, duplication functionality for downlink. For example, the CU 702 may route downlink data between multiple DUs. Similarly, in uplink data, the CU 702 may include functionality for re-ordering. Functionalities of the Edge L2 node 704 may be distributed or duplicated, while functionalities of the CU 702 may not be distributed or duplicated.

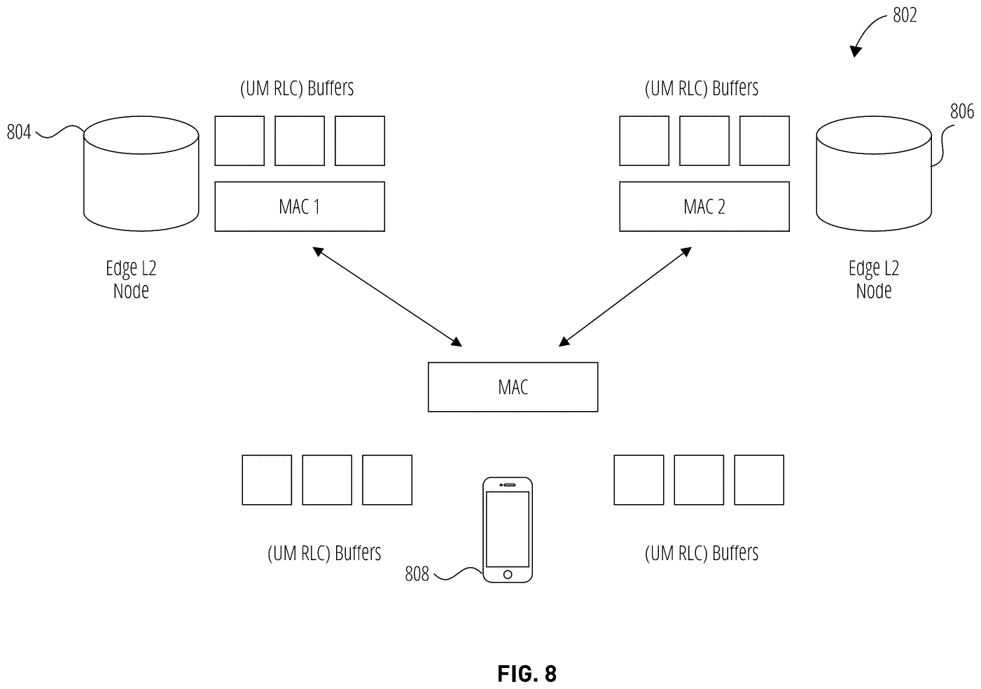

FIG. 8 illustrates a wireless communication system 802 where two edge L2 nodes are in communication with a UE 808 in accordance with some embodiments. Functionalities of the MAC and RLC may be distributed as discussed with reference to FIG. 7. The two L2 nodes (e.g., edge L2 node 804 and edge L2 node 806) can be used to divide or duplicate cell free functionalities. Each edge L2 node may include a MAC layer stack and one or more unacknowledged mode (UM) Radio Link Control (RLC) buffers. The UE 808 may also include RLC buffers corresponding to the edge L2 nodes.

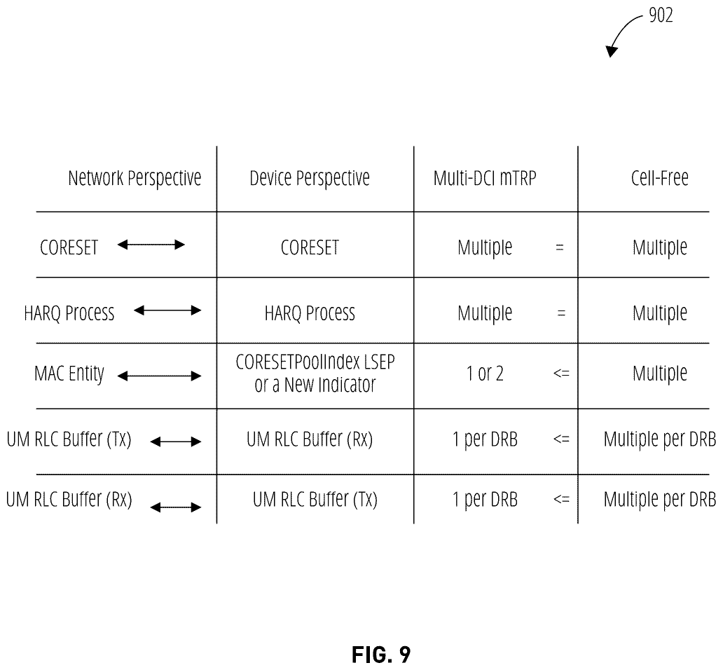

FIG. 9 is a table 902 that illustrates some differences and similarities between Multi-DCI mTRP architecture and cell-free architecture in accordance with some embodiments. As shown, both Multi-DCI mTRP architecture and cell-free architecture may use multiple CORESETs, and multiple HARQ processes.

Further, for the MAC entity the cell-free architecture may use multiple CORESET Pools and multiple HARQ Process Pools. In some embodiments, a HARQ Process Pool is defined as a set of HARQ Process IDs that are used by an Edge L2 Node. A HARQ Process ID may belong to a single HARQ Process Pool. For instance, one node may include HARQ Process IDs in a HARQ Process Pool that are different from those of the second node. The cell-free architecture may use multiple UM RLC Buffer (Tx) per Dedicated Radio Bearer (DRB), and multiple UM RLC Buffer (Rx) per DRB.

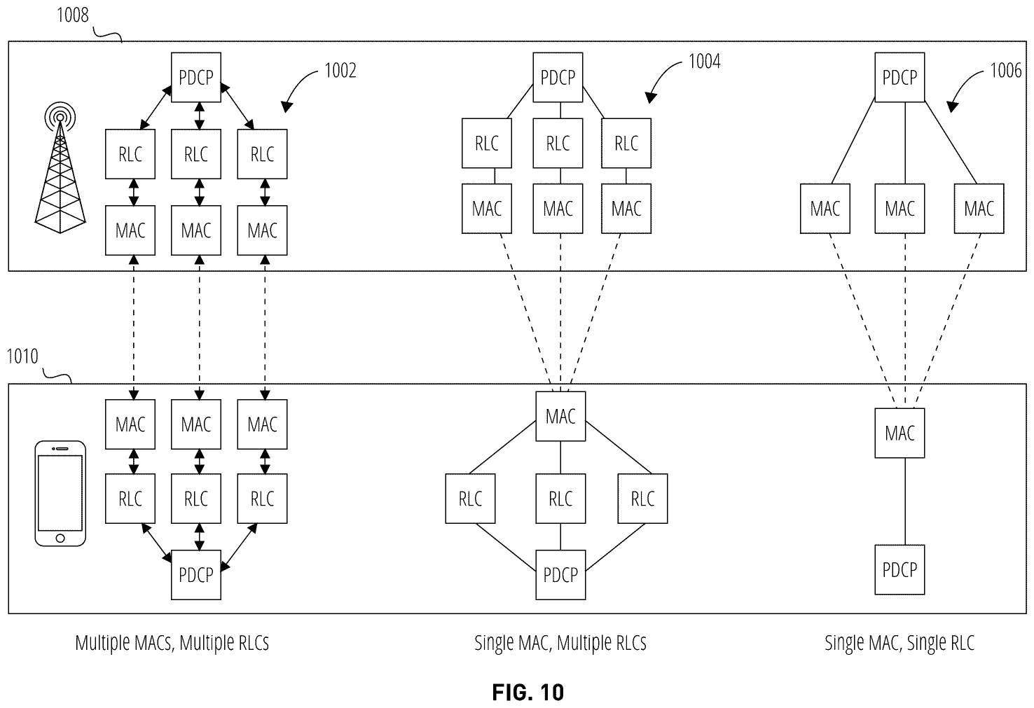

FIG. 10 illustrates three options for distributed cell-Free MIMO architecture in accordance with some embodiments. In the first option 1002, a single radio bearer (RB) is connected to multiple asynchronous RLCs. As shown, in the first option 1002 the network-side 1008 may include a PDCP that is connected to multiple RLC instances, and each of the RLC instances may be connected to a different MAC entity. In the first option 1002, the UE-side 1010 may include MAC entities and RLC instances with a one-to-one corresponded to the network-side 1008. While the RLC instances and the MAC instances may be distributed physically on the network-side 1008, the RLC instances and MAC entities on the UE-side 1010 may be logically implemented.

In the second option 1004, the network-side 1008 may be implemented similar to the network-side 1008. As shown, in the second option 1004 the network-side 1008 may include a PDCP that is connected to multiple RLC instances, and each of the RLC instances may be connected to a different MAC entity. The UE-side 1010 may include a single MAC with multiple assigned resources supporting asynchronous scheduling (multi-DCI). For instance, as shown in the second option 1004, the UE-side 1010 includes a single MAC and multiple RLCs. The RLCs on the UE-side 1010 may have a one-to-one correspondence with the RLCs from the network-side 1008. The single MAC of the UE-side 1010 may be configured to communicate and keep operation with multiple distributed MAC entities on the network-side 1008 by supporting multiple parallel operations (e.g., HARQ processes).

In the third option 1006, illustrates a potential architecture where the RLC layer can be eliminated by combining the functionality of the RLC layer with MAC and supporting only UM operation. In some embodiments, some of the functionality of the RLC layer may be performed by the PDCP and other functionalities of the RLC layer may be performed by the MAC. The elimination of the RLC layer may be on both the network-side 1008 and the UE-side 1010. In some embodiments, the network-side 1008 may include distributed MACs and the UE-side 1010 may comprise a single MAC configured to communicate and keep operation with multiple distributed MAC entities on the network-side 1008 by supporting multiple parallel operations.

Some embodiments herein may provide for L2 functionality splits. In some embodiments, segmentation and/or reassembly can be done both in MAC/RLC and PDCP. In some embodiments segmentation and reassembly may be handled at the MAC and/or RLC level. The use of PDCP for segmentation and reassembly may be optional for low data rate scenarios.

In some embodiments, if there are two MACs on the transmitter side, the transmitter split may be done between MAC and PDCP. In some embodiments, if there are two MACs on the receiver side, the split could be done either between MAC/PDCP (e.g., split #2) or within MAC to let MAC assembly be handled jointly. This may provide an advantage for low data rate Non-Terrestrial Networks (NTN). One advantage of intra-MAC split is for the case when the transmitter has single MAC and is able to support single MAC segmentation process over HARQs dedicated to different receiver MACs. In some embodiments, dedicated feedback message from CU to DU is proposed to let MAC scheduler know about the success of segmentation processes (both MAC and PDCP).

Embodiments herein also consider protocol stack enhancements. In some embodiments, both PDCP and MAC can do retransmissions, but with different mechanisms. In some embodiments, the MAC can allocate data into more than one HARQ, and PDCP can allocate data into more than one Tx Request. In some embodiments, HARQ Process IDs may be UE-specific (not MAC specific), thus MAC entities of the same UE can split the ID sets to avoid collision.

In some embodiments, MAC entity ID may be indicated to the UE. This indication may be performed in multiple ways. In some embodiments, there may be a Downlink Control Information (DCI) indication of MAC entity ID. The DCI may include an indication that the UE may use to determine the MAC entity ID. In some embodiments, HARQ Process IDs may be associated with a given MAC entity ID. This association may be provided to the UE (e.g., semi-statically by a control plane message). In this case, HARQ Process Pool can be defined as a set of HARQ Process IDs associated with the same MAC entity ID. A UE may use the association and the HARQ Process IDs to determine the MAC entity ID.

In some embodiments, both PDCP and MAC can do segmentation/assembly. The support of PDCP segmentation may be optional. If PDCP implements segmentation, it can be advantageous in scenarios with low data rate, more than one MACs at the receiver, and either split option #2 at the receiver or more than one MAC at the transmitter. Otherwise, MAC segmentation may be sufficient for a wireless communication system.

Embodiments herein also consider MAC PDCP split of functionalities. In some embodiments, a split might look like MAC-PDCP split for the transmitter and intra-MAC split for the receiver. Regarding the intra-MAC split option, assembly process may be assumed to be implemented by CU (upper MAC). Thus, the option combines Splits #2, #3 and #5. For example, if the MAC and RLC entities are combined, it may be said that a split may cover split #2 (PDCP/RLC Split), split #3 (RLC entity split), and Split #5 (split within MAC entity). In some embodiments, MAC scheduler can be implemented in a decentralized way (at DU/L2 Edge), centralized way (at CU), or as a combination of both.

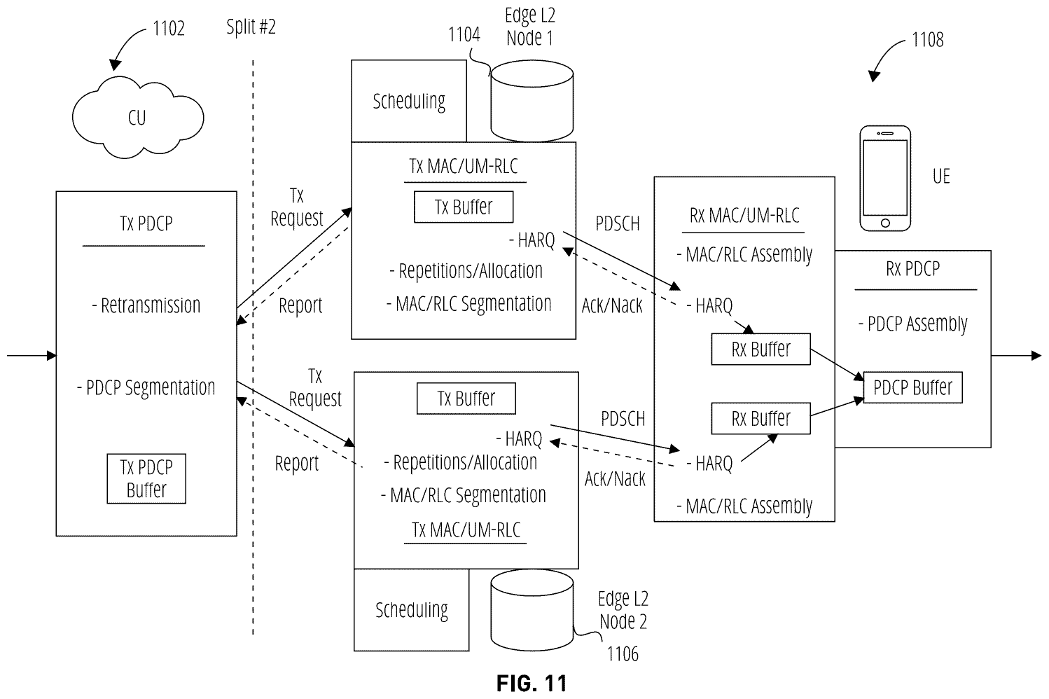

FIG. 11 illustrates an example signal flow diagram for downlink operation with two DUs (e.g., edge L2 node 1104 and edge L2 node 1106) to a UE 1108 in a cell-free architecture in accordance with some embodiments. The option of placing network functions in different places along the signal path may be referred to as a functional split. The signal flow diagram illustrates downlink operation with an L2 functionality split (e.g., split option #2). The split option #2 may refer to a functionality split between the PDCP and the RLC layer (if there is an RLC layer) or a functionality split between the PDCP and the MAC entity (when the MAC entity includes the RLC functionalities).

The illustrated embodiment shows signaling between a CU 1102, the edge L2 nodes, and a UE 1108. In addition, the illustrated embodiment includes functionalities that may be performed at each of these entities. As shown, the CU 1102 may include a transmit (Tx) PDCP functionality. In some embodiments, the Tx PDCP may implement one or both of PDCP segmentation and retransmission. The retransmission done by the PDCP may cause downlink data transmissions to be subject to acknowledgment and potential retransmission if errors occur or packets are lost. For example, the need for retransmission may be determined through the TX request and report between the edge L2 nodes and the CU. The PDCP segmentation may allow the PDCP to segment larger packets or data units into smaller segments before transmitting them to the edge L2 nodes. As shown, the CU 1102 may also include a Tx PDCP buffer to assist with segmentation and retransmission.

The illustrated embodiment includes two edge L2 nodes (i.e., edge L2 node 1104 and edge L2 node 1106). Additional edge L2 nodes may be used. As shown, the edge L2 nodes may include one or more MAC entities and one or more UM-RLC instances. As discussed previously, the MAC and the UM-RLC instance may be separate or combined. The functionalities of the MAC/UM-RLC may include repetitions and allocation, MAC/RLC segmentation, and HARQ processes. As shown, the edge L2 nodes may include a buffer that may be used for these functionalities. As shown, the CU 1102 and the edge L2 nodes may both have buffers, a multi-buffer operation may (TX request and Report) may be used to share data between buffers. Further, the edge L2 nodes may make at least some scheduling decisions.

The UE 1108 may include an architecture that mirrors the network architecture. For example, the UE 1108 may include one or more receiving (Rx) MAC/UM-RLC entities and an Rx PDCP. The Rx MAC/UM-RLC may be separate or combined. The functionalities of the Rx MAC/UM-RLC may include MAC/RLC Assembly and HARQ processes. Further, the Rx MAC/UM-RLC may include one or more buffers that may be used for these functionalities. As shown, the buffers may correspond to the edge L2 nodes. The Rx PDCP of the UE 1108 may perform PDCP assembly and include a PDCP buffer.

As shown in the illustrated embodiment, there may be two-layer segmentation and two-layer assembly. For example, packet data units may be segmented by the PDCP at the CU 1102 and again at one or more of the edge L2 nodes using the multiple levels of buffers. Similarly, assembly of the packet data units can occur at the MA/UM-RLC of the UE edge L2 node UE 1108 and at the PDCP of the UE 1108 using the multiple levels of buffers.

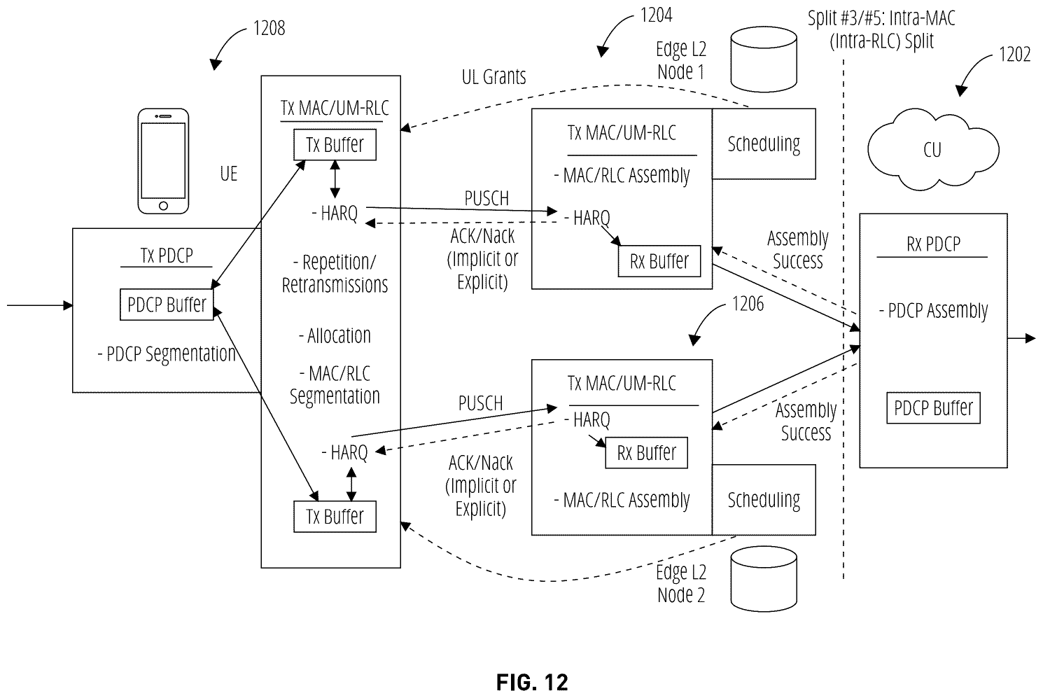

FIG. 12 illustrates an example signal flow diagram for uplink operation with two DUs (e.g., edge L2 node 1204 and edge L2 node 1206) to a UE 1208 in a cell-free architecture in accordance with some embodiments. The illustrated embodiments employ a split option #2 where the functionality split is between the PDCP and the RLC layer (if there is an RLC layer) or a functionality split between the PDCP and the MAC entity (when the MAC entity includes the RLC functionalities).

As shown, the UE 1208 may include one or more Tx MAC/UM-RLC entities and a Tx PDCP. The Tx PDCP of the UE 1208 may perform PDCP segmentation and include a PDCP buffer to store data that is segmented. The PDCP segmentation may allow the PDCP to segment larger packets or data units into smaller segments before they are sent to the MAC/UM-RLC layer. The functionalities of the MAC/UM-RLC may include repetitions and allocation, MAC/RLC segmentation, and HARQ processes. As shown, the edge L2 nodes may include one or more buffers that may be used for these functionalities. The number of buffers may correspond to the number of MAC/UM-RLC entities at the network side. Using the PDCP buffer and the MAC-UM-RLC buffers, the UE 1208 may perform segmentation to packet data units at multiple levels.

The UE 1308 may send a PUSCH transmission to the edge L2 nodes. The UE 1308 may receive an implicit or explicit acknowledgment (ACK) or negative acknowledgement (NACK) from the edge L2 node and an uplink grant. In some embodiments, data pulling from the PDCP buffer may be triggered by reception of grants for UL transmission (PUSCH). The edge L2 nodes may include a MAC/UM-RLC that performs MAC/RLC Assembly and HARQ processes. Further, the Rx MAC/UM-RLC may include one or more buffers that may be used for these functionalities. The edge L2 nodes may also make scheduling decisions such that result in the uplink grant.

The edge L2 nodes may transmit the data to the CU 1202. The CU 1202 may include a PDCP and a PDCP buffer. The PDCP may perform PDCP assembly using the PDCP buffer to store data from the edge L2 nodes. In some embodiments, the CU 1202 may generate and send a PDCP Assembly success report to the edge L2 nodes. The PDCP Assembly success report may be used for scheduler optimization at the edge L2 nodes. For example, a packet data unit may be segmented across multiple edge L2 nodes. When the CU 1202 successfully assembles the data from a packet data unit it may send this report to the lower layers at the edge L2 nodes informing them that the packet data unit was assembled. This report may provide a clue to the nodes about the data the other nodes have already delivered. As shown, the network may use two-layer assembly and the UE may use two-layer segmentation.

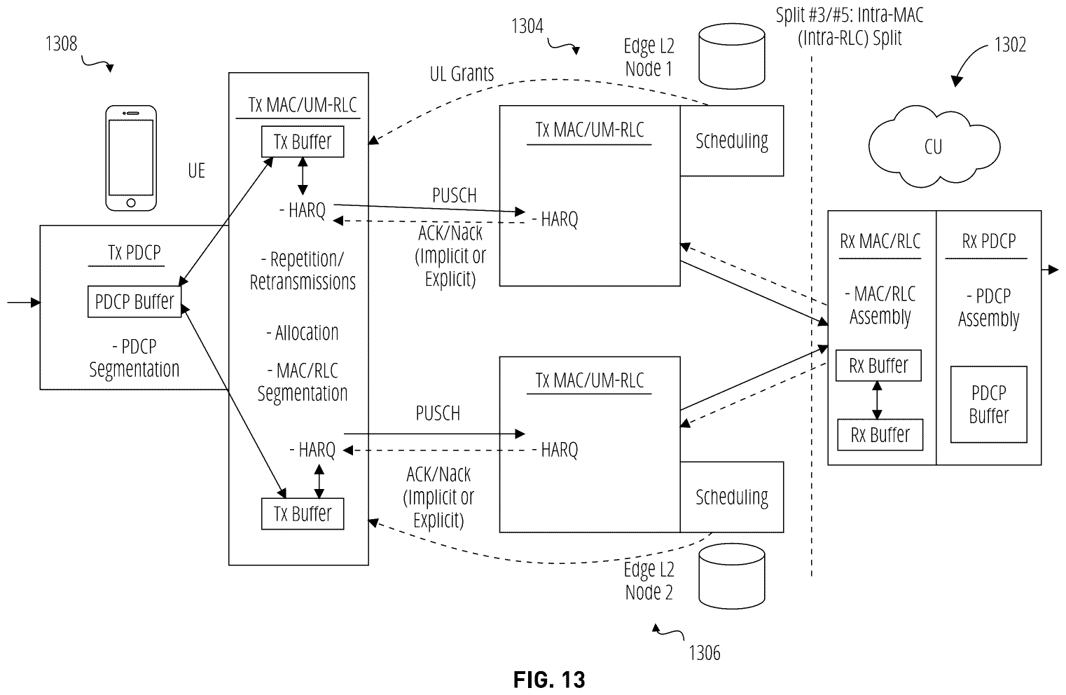

FIG. 13 illustrates an example signal flow diagram for uplink operation with two DUs (e.g., edge L2 node 1304 and edge L2 node 1306) to a UE 1308 in a cell-free architecture with an intra-MAC/intra-RLC split in accordance with some embodiments. The illustrated embodiments employ a split option #3/#5 where the functionality split is intra-MAC/intra-RLC. As shown, some MAC and RLC functionalities may be performed at the edge L2 nodes, and some functionalities of the MAC/RLC may be performed at the CU 1302.

As shown, the UE 1308 may include one or more Tx MAC/UM-RLC entities and a Tx PDCP. The Tx PDCP of the UE 1308 may perform PDCP segmentation and include a PDCP buffer to store data that is segmented. The PDCP segmentation may allow the PDCP to segment larger packets or data units into smaller segments before they are sent to the MAC/UM-RLC layer. The functionalities of the MAC/UM-RLC may include repetitions and allocation, MAC/RLC segmentation, and HARQ processes. As shown, the edge L2 nodes may include one or more buffers that may be used for these functionalities. The number of buffers may correspond to the number of MAC/UM-RLC entities at the network side. Using the PDCP buffer and the MAC-UM-RLC buffers, the UE 1308 may perform segmentation to packet data units at multiple levels.

The UE 1308 may send a PUSCH transmission to the edge L2 nodes. The UE 1308 may receive an implicit or explicit ACK or NACK from the edge L2 node and an uplink grant. In some embodiments, data pulling from the PDCP buffer may be triggered by reception of grants for UL transmission (PUSCH). The edge L2 nodes may include a MAC/UM-RLC that performs MAC/RLC HARQ processes. The data from the UE 1308 received by the edge L2 node may be transmitted to the CU 1302.

The CU 1302 may include an Rx MAC UM-RLC functionality and buffers corresponding to the edge L2 nodes. The Rx MAC/UM-RLC may use the buffers for MAC/RLC assembly. The CU 1302 may also include a PDCP and a PDCP buffer. The PDCP may perform PDCP assembly using the PDCP buffer. In some embodiments, the CU 1302 may generate and send a MAC/RLC and PDCP Assembly success report to the edge L2 nodes. The MAC/RLC and PDCP Assembly success report may indicate that the CU 1302 successfully performed assembly at the AMC/RLC layer and at the PDCP layer. This report may be used for scheduler optimization at the edge L2 nodes. For example, a packet data unit may be segmented across multiple edge L2 nodes. When the CU 1202 successfully assembles the data from a packet data unit it may send this report to the lower layers at the edge L2 nodes informing them that the packet data unit was assembled. This report may provide a clue to the nodes about the data the other nodes have already delivered. As shown the network may use two-layer assembly and the UE may use two-layer segmentation.

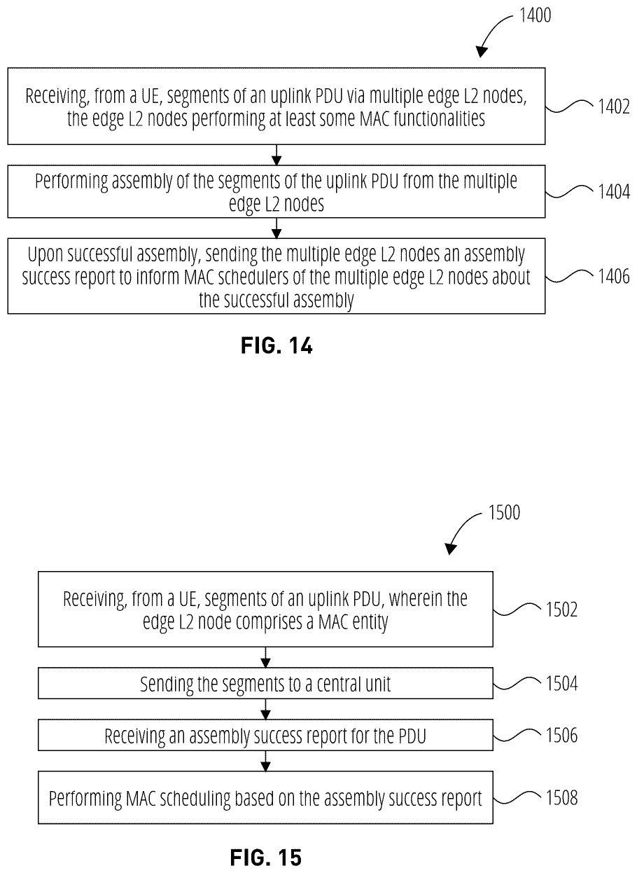

FIG. 14 illustrates a method 1400 performed by a central unit network node, according to embodiments herein. The illustrated method 1400 includes receiving 1402, from a UE, segments of an uplink PDU via multiple edge L2 nodes, the edge L2 nodes performing at least some MAC functionalities. The method 1400 further includes performing 1404 assembly of the segments of the uplink PDU from the multiple edge L2 nodes. The method 1400 further includes, upon successful assembly, sending 1406 the multiple edge L2 nodes an assembly success report to inform MAC schedulers of the multiple edge L2 nodes about the successful assembly.

In some embodiments of the method 1400, assembly is performed both in MAC and PDCP.

In some embodiments, the method 1400 further comprises segmenting a downlink PDU, and sending portions of the downlink PDU to the multiple edge L2 nodes, wherein the central unit network node comprises a PDCP entity and the multiple edge L2 nodes each comprise a MAC entity, wherein a transmitter functionality split is between the MAC entities and the PDCP entity.

In some embodiments of the method 1400, the central unit network node comprises a PDCP entity and the multiple edge L2 nodes each comprise a MAC entity, wherein a receiver functionality split is between the MAC entities and the PDCP entity.

In some embodiments of the method 1400, a receiver functionality split is within a MAC layer such that the central unit network node performs both MAC assembly and PDCP assembly.

In some embodiments, the method 1400 further comprises segmenting a downlink PDU, wherein assembly and segmentation are performed by both a PDCP entity at the central unit network node, and one or more MAC entities at either the central unit network node or the multiple edge L2 nodes.

In some embodiments, the method 1400 further comprises sending a downlink PDU, and retransmitting the downlink PDU, wherein both a PDCP entity and one or more MAC entities are configured for retransmissions with different mechanisms, wherein the one or more MAC entities allocate data into more than one HARQ, and the PDCP entity allocates data into more than one transmit requests.

In some embodiments, the method 1400 further comprises indicating a MAC entity ID to the UE via a DCI indication of the MAC entity ID, or associating HARQ Process IDs with the MAC entity ID.

In some embodiments of the method 1400, both MAC and PDCP include a buffer for segmentation and assembly.

FIG. 15 illustrates a method 1500 performed by an edge L2 node serving as a distributed unit, according to embodiments herein. The illustrated method 1500 includes receiving 1502, from a UE, segments of an uplink PDU, wherein the edge L2 node comprises a MAC entity. The method 1500 further includes sending 1504 the segments to a central unit. The method 1500 further includes receiving 1506 an assembly success report for the PDU. The method 1500 further includes performing 1508 MAC scheduling based on the assembly success report.

In some embodiments, the method 1500 further comprises retransmitting a downlink PDU by allocating data into more than one HARQ.

In some embodiments, the method 1500 further comprises performing HARQ processes, wherein HARQ Process IDs are UE-specific and not MAC specific such that MAC entities of the UE split the ID sets to avoid collision.

In some embodiments, the method 1500 further comprises performing MAC assembly on the uplink PDU, and performing MAC segmentation on a downlink PDU.

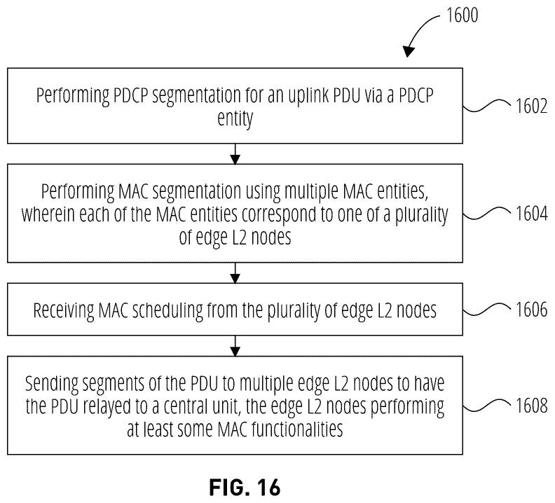

FIG. 16 illustrates a method 1600 performed by a UE, according to embodiments herein. The method 1600 includes performing 1602 PDCP segmentation for an uplink PDU via a PDCP entity. The method 1600 further includes performing 1604 MAC segmentation using multiple MAC entities, wherein each of the MAC entities correspond to one of a plurality of edge L2 nodes. The method 1600 further includes receiving 1606 MAC scheduling from the plurality of edge L2 nodes. The method 1600 further includes sending 1608 segments of the PDU to multiple edge L2 nodes to have the PDU relayed to a central unit, the edge L2 nodes performing at least some MAC functionalities.

In some embodiments, the method 1600 further comprises assembling a downlink PDU, wherein assembly is performed both in the MAC entities and the PDCP entity.

In some embodiments, the method 1600 further comprises retransmitting the uplink PDU, wherein both the PDCP entity and the MAC entities are configured for retransmissions with different mechanisms, wherein the MAC entities allocate data into more than one HARQ, and the PDCP entity allocates data into more than one transmit request.

In some embodiments, the method 1600 further comprises receiving an indication of a MAC entity ID via a DCI indication of the MAC entity ID.

In some embodiments, the method 1600 further comprises receiving an indication of a MAC entity ID based on an associated HARQ Process ID with the MAC entity ID.

In some embodiments of the method 1600, both the MAC entities and PDCP entity include a buffer for segmentation and assembly.

In some embodiments of the method 1600, an amount of the MAC entities at the UE corresponds to a number of network MAC entities at the edge L2 nodes.

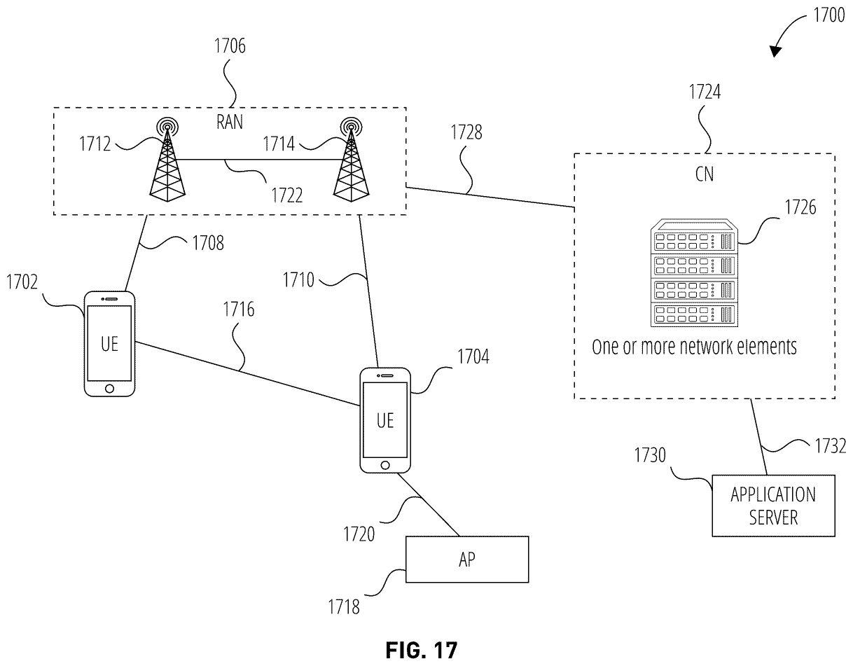

FIG. 17 illustrates an example architecture of a wireless communication system 1700, according to embodiments disclosed herein. The following description is provided for an example wireless communication system 1700 that operates in conjunction with the LTE system standards and/or 5G or NR system standards as provided by 3GPP technical specifications.

As shown by FIG. 17, the wireless communication system 1700 includes UE 1702 and UE 1704 (although any number of UEs may be used). In this example, the UE 1702 and the UE 1704 are illustrated as smartphones (e.g., handheld touchscreen mobile computing devices connectable to one or more cellular networks) but may also comprise any mobile or non-mobile computing device configured for wireless communication.

The UE 1702 and UE 1704 may be configured to communicatively couple with a RAN 1706. In embodiments, the RAN 1706 may be NG-RAN, E-UTRAN, etc. The UE 1702 and UE 1704 utilize connections (or channels) (shown as connection 1708 and connection 1710, respectively) with the RAN 1706, each of which comprises a physical communications interface. The RAN 1706 can include one or more base stations (such as base station 1712 and base station 1714) that enable the connection 1708 and connection 1710.

In this example, the connection 1708 and connection 1710 are air interfaces to enable such communicative coupling and may be consistent with RAT(s) used by the RAN 1706, such as, for example, an LTE and/or NR.

In some embodiments, the UE 1702 and UE 1704 may also directly exchange communication data via a sidelink interface 1716. The UE 1704 is shown to be configured to access an access point (shown as AP 1718) via connection 1720. By way of example, the connection 1720 can comprise a local wireless connection, such as a connection consistent with any IEEE 802.11 protocol, wherein the AP 1718 may comprise a Wi-Fi® router. In this example, the AP 1718 may be connected to another network (for example, the Internet) without going through a CN 1724.

In embodiments, the UE 1702 and UE 1704 can be configured to communicate using orthogonal frequency division multiplexing (OFDM) communication signals with each other or with the base station 1712 and/or the base station 1714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1712 or base station 1714 may be implemented as one or more software entities running on server computers as part of a virtual network. In addition, or in other embodiments, the base station 1712 or base station 1714 may be configured to communicate with one another via interface 1722. In embodiments where the wireless communication system 1700 is an LTE system (e.g., when the CN 1724 is an EPC), the interface 1722 may be an X2 interface. The X2 interface may be defined between two or more base stations (e.g., two or more eNBs and the like) that connect to an EPC, and/or between two eNBs connecting to the EPC. In embodiments where the wireless communication system 1700 is an NR system (e.g., when CN 1724 is a 5GC), the interface 1722 may be an Xn interface. The Xn interface is defined between two or more base stations (e.g., two or more gNBs and the like) that connect to 5GC, between a base station 1712 (e.g., a gNB) connecting to 5GC and an eNB, and/or between two eNBs connecting to 5GC (e.g., CN 1724).

The RAN 1706 is shown to be communicatively coupled to the CN 1724. The CN 1724 may comprise one or more network elements 1726, which are configured to offer various data and telecommunications services to customers/subscribers (e.g., users of UE 1702 and UE 1704) who are connected to the CN 1724 via the RAN 1706. The components of the CN 1724 may be implemented in one physical device or separate physical devices including components to read and execute instructions from a machine-readable or computer-readable medium (e.g., a non-transitory machine-readable storage medium).

In embodiments, the CN 1724 may be an EPC, and the RAN 1706 may be connected with the CN 1724 via an S1 interface 1728. In embodiments, the S1 interface 1728 may be split into two parts, an S1 user plane (S1-U) interface, which carries traffic data between the base station 1712 or base station 1714 and a serving gateway (S-GW), and the S1-MME interface, which is a signaling interface between the base station 1712 or base station 1714 and mobility management entities (MMEs).

In embodiments, the CN 1724 may be a 5GC, and the RAN 1706 may be connected with the CN 1724 via an NG interface 1728. In embodiments, the NG interface 1728 may be split into two parts, an NG user plane (NG-U) interface, which carries traffic data between the base station 1712 or base station 1714 and a user plane function (UPF), and the S1 control plane (NG-C) interface, which is a signaling interface between the base station 1712 or base station 1714 and access and mobility management functions (AMFs).

Generally, an application server 1730 may be an element offering applications that use internet protocol (IP) bearer resources with the CN 1724 (e.g., packet switched data services). The application server 1730 can also be configured to support one or more communication services (e.g., VOIP sessions, group communication sessions, etc.) for the UE 1702 and UE 1704 via the CN 1724. The application server 1730 may communicate with the CN 1724 through an IP communications interface 1732.

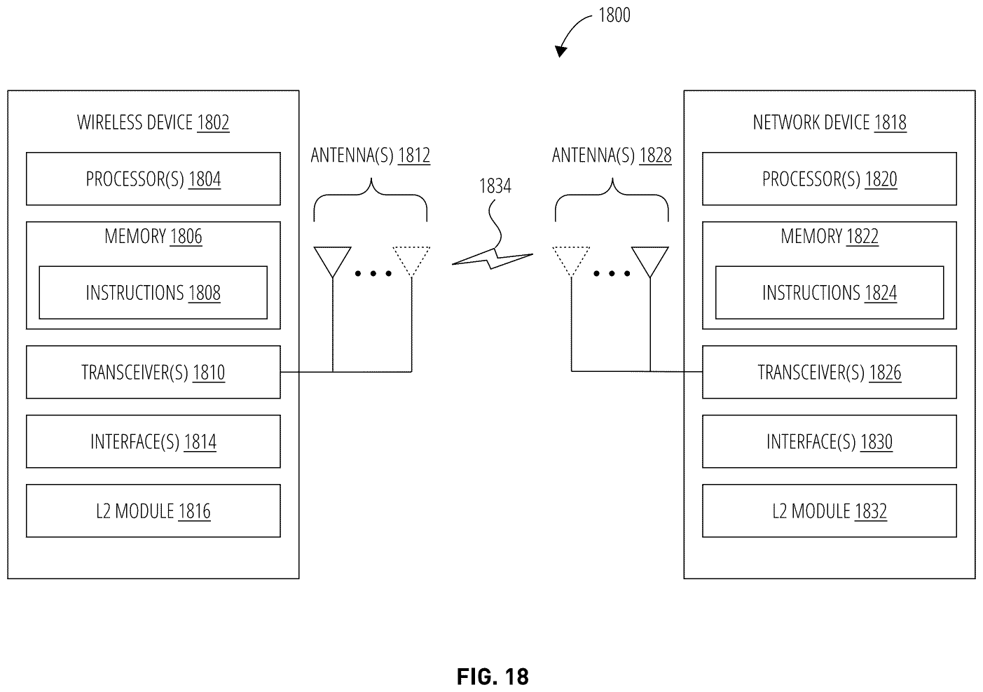

FIG. 18 illustrates a system 1800 for performing signaling 1834 between a wireless device 1802 and a network device 1818, according to embodiments disclosed herein. The system 1800 may be a portion of a wireless communications system as herein described. The wireless device 1802 may be, for example, a UE of a wireless communication system. The network device 1818 may be, for example, a base station (e.g., an eNB or a gNB) of a wireless communication system.

The wireless device 1802 may include one or more processor(s) 1804. The processor(s) 1804 may execute instructions such that various operations of the wireless device 1802 are performed, as described herein. The processor(s) 1804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1802 may include a memory 1806. The memory 1806 may be a non-transitory computer-readable storage medium that stores instructions 1808 (which may include, for example, the instructions being executed by the processor(s) 1804). The instructions 1808 may also be referred to as program code or a computer program. The memory 1806 may also store data used by, and results computed by, the processor(s) 1804.

The wireless device 1802 may include one or more transceiver(s) 1810 that may include radio frequency (RF) transmitter circuitry and/or receiver circuitry that use the antenna(s) 1812 of the wireless device 1802 to facilitate signaling (e.g., the signaling 1834) to and/or from the wireless device 1802 with other devices (e.g., the network device 1818) according to corresponding RATs.

The wireless device 1802 may include one or more antenna(s) 1812 (e.g., one, two, four, or more). For embodiments with multiple antenna(s) 1812, the wireless device 1802 may leverage the spatial diversity of such multiple antenna(s) 1812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1802 may be accomplished according to precoding (or digital beamforming) that is applied at the wireless device 1802 that multiplexes the data streams across the antenna(s) 1812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the wireless device 1802 may implement analog beamforming techniques, whereby phases of the signals sent by the antenna(s) 1812 are relatively adjusted such that the (joint) transmission of the antenna(s) 1812 can be directed (this is sometimes referred to as beam steering).

The wireless device 1802 may include one or more interface(s) 1814. The interface(s) 1814 may be used to provide input to or output from the wireless device 1802. For example, a wireless device 1802 that is a UE may include interface(s) 1814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1810/antenna(s) 1812 already described) that allow for communication between the UE and other devices and may operate according to known protocols (e.g., Wi-Fi®, Bluetooth®, and the like).

The wireless device 1802 may include an L2 module 1816. The L2 module 1816 may be implemented via hardware, software, or combinations thereof. For example, the L2 module 1816 may be implemented as a processor, circuit, and/or instructions 1808 stored in the memory 1806 and executed by the processor(s) 1804. In some examples, the L2 module 1816 may be integrated within the processor(s) 1804 and/or the transceiver(s) 1810. For example, the L2 module 1816 may be implemented by a combination of software components (e.g., executed by a DSP or a general processor) and hardware components (e.g., logic gates and circuitry) within the processor(s) 1804 or the transceiver(s) 1810.

The L2 module 1816 may be used for various aspects of the present disclosure, for example, aspects of FIGS. 1-17.

The network device 1818 may include one or more processor(s) 1820. The processor(s) 1820 may execute instructions such that various operations of the network device 1818 are performed, as described herein. The processor(s) 1820 may include one or more baseband processors implemented using, for example, a CPU, a DSP, an ASIC, a controller, an FPGA device, another hardware device, a firmware device, or any combination thereof configured to perform the operations described herein.

The network device 1818 may include a memory 1822. The memory 1822 may be a non-transitory computer-readable storage medium that stores instructions 1824 (which may include, for example, the instructions being executed by the processor(s) 1820). The instructions 1824 may also be referred to as program code or a computer program. The memory 1822 may also store data used by, and results computed by, the processor(s) 1820.

The network device 1818 may include one or more transceiver(s) 1826 that may include RF transmitter circuitry and/or receiver circuitry that use the antenna(s) 1828 of the network device 1818 to facilitate signaling (e.g., the signaling 1834) to and/or from the network device 1818 with other devices (e.g., the wireless device 1802) according to corresponding RATs.

The network device 1818 may include one or more antenna(s) 1828 (e.g., one, two, four, or more). In embodiments having multiple antenna(s) 1828, the network device 1818 may perform MIMO, digital beamforming, analog beamforming, beam steering, etc., as has been described.

The network device 1818 may include one or more interface(s) 1830. The interface(s) 1830 may be used to provide input to or output from the network device 1818. For example, a network device 1818 that is a base station may include interface(s) 1830 made up of transmitters, receivers, and other circuitry (e.g., other than the transceiver(s) 1826/antenna(s) 1828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1818 may include an L2 module 1832. The L2 module 1832 may be implemented via hardware, software, or combinations thereof. For example, the L2 module 1832 may be implemented as a processor, circuit, and/or instructions 1824 stored in the memory 1822 and executed by the processor(s) 1820. In some examples, the L2 module 1832 may be integrated within the processor(s) 1820 and/or the transceiver(s) 1826. For example, the L2 module 1832 may be implemented by a combination of software components (e.g., executed by a DSP or a general processor) and hardware components (e.g., logic gates and circuitry) within the processor(s) 1820 or the transceiver(s) 1826.

The L2 module 1832 may be used for various aspects of the present disclosure, for example, aspects of FIGS. 1-17.

Embodiments contemplated herein include an apparatus comprising means to perform one or more elements of the method 1600. This apparatus may be, for example, an apparatus of a UE (such as a wireless device 1802 that is a UE, as described herein).

Embodiments contemplated herein include one or more non-transitory computer-readable media comprising instructions to cause an electronic device, upon execution of the instructions by one or more processors of the electronic device, to perform one or more elements of the method 1600. This non-transitory computer-readable media may be, for example, a memory of a UE (such as a memory 1806 of a wireless device 1802 that is a UE, as described herein).

Embodiments contemplated herein include an apparatus comprising logic, modules, or circuitry to perform one or more elements of the method 1600. This apparatus may be, for example, an apparatus of a UE (such as a wireless device 1802 that is a UE, as described herein).

Embodiments contemplated herein include an apparatus comprising: one or more processors and one or more computer-readable media comprising instructions that, when executed by the one or more processors, cause the one or more processors to perform one or more elements of the method 1600. This apparatus may be, for example, an apparatus of a UE (such as a wireless device 1802 that is a UE, as described herein).

Embodiments contemplated herein include a signal as described in or related to one or more elements of the method 1600.

Embodiments contemplated herein include a computer program or computer program product comprising instructions, wherein execution of the program by a processor is to cause the processor to carry out one or more elements of the method 1600. The processor may be a processor of a UE (such as a processor(s) 1804 of a wireless device 1802 that is a UE, as described herein). These instructions may be, for example, located in the processor and/or on a memory of the UE (such as a memory 1806 of a wireless device 1802 that is a UE, as described herein).

Embodiments contemplated herein include an apparatus comprising means to perform one or more elements of any one of the method 1400 and the method 1500. This apparatus may be, for example, an apparatus of a base station (such as a network device 1818 that is a base station, as described herein).

Embodiments contemplated herein include one or more non-transitory computer-readable media comprising instructions to cause an electronic device, upon execution of the instructions by one or more processors of the electronic device, to perform one or more elements of any one of the method 1400 and the method 1500. This non-transitory computer-readable media may be, for example, a memory of a base station (such as a memory 1822 of a network device 1818 that is a base station, as described herein).

Embodiments contemplated herein include an apparatus comprising logic, modules, or circuitry to perform one or more elements of any one of the method 1400 and the method 1500. This apparatus may be, for example, an apparatus of a base station (such as a network device 1818 that is a base station, as described herein).

Embodiments contemplated herein include an apparatus comprising: one or more processors and one or more computer-readable media comprising instructions that, when executed by the one or more processors, cause the one or more processors to perform one or more elements of any one of the method 1400 and the method 1500. This apparatus may be, for example, an apparatus of a base station (such as a network device 1818 that is a base station, as described herein).

Embodiments contemplated herein include a signal as described in or related to one or more elements of any one of the method 1400 and the method 1500.

Embodiments contemplated herein include a computer program or computer program product comprising instructions, wherein execution of the program by a processing element is to cause the processing element to carry out one or more elements of any one of the method 1400 and the method 1500. The processor may be a processor of a base station (such as a processor(s) 1820 of a network device 1818 that is a base station, as described herein). These instructions may be, for example, located in the processor and/or on a memory of the base station (such as a memory 1822 of a network device 1818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a central unit network node, the method comprising:
receiving, from a user equipment (UE), segments of an uplink packet data unit (PDU) via multiple edge layer 2 (L2) nodes, the edge L2 nodes performing at least some Medium Access Control (MAC) functionalities;
performing assembly of the segments of the uplink PDU from the multiple edge L2 nodes; and
upon successful assembly, sending the multiple edge L2 nodes an assembly success report to inform MAC schedulers of the multiple edge L2 nodes about the successful assembly.

2. The method of claim 1, wherein assembly is performed both in MAC and Packet Data Convergence Protocol (PDCP).

3. The method of claim 1, further comprising:
segmenting a downlink PDU; and
sending portions of the downlink PDU to the multiple edge L2 nodes, wherein the central unit network node comprises a PDCP entity and the multiple edge L2 nodes each comprise a MAC entity, wherein a transmitter functionality split is between the MAC entities and the PDCP entity.

4. The method of claim 1, wherein the central unit network node comprises a PDCP entity and the multiple edge L2 nodes each comprise a MAC entity, wherein a receiver functionality split is between the MAC entities and the PDCP entity.

5. The method of claim 1, wherein a receiver functionality split is within a MAC layer such that the central unit network node performs both MAC assembly and PDCP assembly.

6. The method of claim 1, further comprising segmenting a downlink PDU, wherein assembly and segmentation are performed by both a PDCP entity at the central unit network node, and one or more MAC entities at either the central unit network node or the multiple edge L2 nodes.

7. The method of claim 1, further comprising sending a downlink PDU; and
retransmitting the downlink PDU, wherein both a PDCP entity and one or more MAC entities are configured for retransmissions with different mechanisms, wherein the one or more MAC entities allocate data into more than one Hybrid Automatic Repeat Request (HARQ), and the PDCP entity allocates data into more than one transmit requests.

8. The method of claim 1, further comprising indicating a MAC entity ID to the UE via a Downlink Control Information (DCI) indication of the MAC entity ID, or associating HARQ Process IDs with the MAC entity ID.

9. The method of claim 1, wherein both MAC and PDCP include a buffer for segmentation and assembly.

10. A method performed by an edge layer 2 (L2) node serving as a distributed unit, the method comprising:
receiving, from a user equipment (UE), segments of an uplink packet data unit (PDU), wherein the edge L2 node comprises a MAC entity;
sending the segments to a central unit;
receiving an assembly success report for the PDU; and
performing medium access control (MAC) scheduling based on the assembly success report.

11. The method of claim 10, further comprising retransmitting a downlink PDU by allocating data into more than one Hybrid Automatic Repeat Request (HARQ).

12. The method of claim 10, further comprising performing Hybrid Automatic Repeat Request (HARQ) processes, wherein HARQ Process IDs are UE-specific and not MAC specific such that MAC entities of the UE split the ID sets to avoid collision.

13. The method of claim 10, further comprising performing MAC assembly on the uplink PDU, and performing MAC segmentation on a downlink PDU.

14. A method performed by a user equipment UE, the method comprising:
performing Packet Data Convergence Protocol (PDCP) segmentation for an uplink packet data unit (PDU) via a PDCP entity;
performing Medium Access Control (MAC) segmentation using multiple MAC entities, wherein each of the MAC entities correspond to one of a plurality of edge layer 2 (L2) nodes;
receiving MAC scheduling from the plurality of edge L2 nodes; and
sending segments of the PDU to multiple edge L2 nodes to have the PDU relayed to a central unit, the edge L2 nodes performing at least some Medium Access Control (MAC) functionalities.

15. The method of claim 14, further comprising assembling a downlink PDU, where in assembly is performed both in the MAC entities and the PDCP entity.

16. The method of claim 14, further comprising retransmitting the uplink PDU, wherein both the PDCP entity and the MAC entities are configured for retransmissions with different mechanisms, wherein the MAC entities allocate data into more than one Hybrid Automatic Repeat Request (HARQ), and the PDCP entity allocates data into more than one transmit requests.

17. The method of claim 14, further comprising receiving an indication of a MAC entity ID via a Downlink Control Information (DCI) indication of the MAC entity ID.

18. The method of claim 14, further comprising receiving an indication of a MAC entity ID based on an associated HARQ Process ID with the MAC entity ID.

19. The method of claim 14, wherein both the MAC entities and PDCP entity include a buffer for segmentation and assembly.

20. The method of claim 14, wherein an amount of the MAC entities at the UE corresponds to a number of network MAC entities at the edge L2 nodes.
